(19) United States
(12) Patent Application Publication
(10) Pub. No.: US 2008/0093765 A1
(43) Pub. Date: Apr. 24, 2008

(54) Method of making a hockey stick blade

(75) Inventors: Leo Sartor, Montebelluna (IT); Angelo Montemurro, Chiavenna (IT); Alain Bellefleur, St-Luc (CA)

Correspondence Address: Ralph A. Dowell of DOWELL & DOWELL P.C., 2111 Eisenhower Ave, Suite 406, Alexandria, VA, 22314, US

(73) Assignee: BAUER NIKE HOCKEY INC., St-Jerome (CA)

(21) Appl. No.: 11/907,502

(22) Filed: Oct. 12, 2007

Related U.S. Application Data
(63) Continuation of application No. 10/772,316, filed on Feb. 6, 2004.

(51) Int. Cl. B29C 41/02

(52) U.S. Cl. 264/103

(57) ABSTRACT

A method of making a hockey stick blade with a shank and a blade element having a front external surface and a rear external surface, the method comprising: (a)selecting a core made of thermo-expandable foam; (b) forming a preformed blade by wrapping the core with first and second layers of fibers pre-impregnated with resin; (c) selecting front and rear thermoplastic sheets for covering at least partially the second layer of fibers, for forming part of the respective front and rear external surfaces of the blade element and for increasing the impact resistance of the hockey stick blade; (d) placing the front and rear thermoplastic sheets and the preformed blade in a mold such that the preformed blade is between the front and rear thermoplastic sheets; (e) applying heat to the mold; and (f) when said resin is cured, removing the hockey stick blade from the mold.

The present application is a continuation of U.S. patent application Ser. No. 10/772,316 filed on Feb. 6, 2004. The content of this application is hereby incorporated by reference herein.

### FIELD OF THE INVENTION

The present invention relates to a method of making a hockey stick blade comprising front and rear surfaces with front and rear sheets of thermoplastic material.

### BACKGROUND OF THE INVENTION

Typical hockey stick blades or replacement blades are generally made of a wooden core reinforced with one or more layers of synthetic material such as fiberglass, carbon fibers or graphite. The core of the blade may also be made of a synthetic material reinforced with layers of fibers material. The layers are usually made of woven filament fibers, typically soaked in a resin and glued to the surfaces of the core of the blade. Expandable fibers braids may also be used for recovering the core of the blade.

Canadian Patent Application 2,228,104 discloses a hockey stick comprising a wooden shaft and a composite blade with a pre-form core made of thermoplastic polyurethane foam. The pre-form core is recovered of braided glass socks and layers of reinforcing materials.

U.S. Pat. No. 5,048,878 discloses an expanded polyvinyl chloride foam core stick wherein the core is covered with meshes of fiberglass or carbon fibers.

U.S. Pat. No. 5,333,857 discloses a hockey stick comprising a shaft section, a blade section and a heel section forming the connection between the blade and shaft sections. The stick comprises a core made of synthetic foam having a first density for the shaft, a second density for the heel and a third density for the blade. The core is covered with three layers of woven materials.

There is a demand for an improved hockey stick blade having a better impact resistance.

### SUMMARY OF THE INVENTION

As embodied and broadly described herein, the invention provides a method of making a hockey stick blade with a shank and a blade element having a front external surface and a rear external surface, the method comprising: (a)selecting a core made of thermo-expandable foam; (b) forming a preformed blade by wrapping the core with first and second layers of fibers pre-impregnated with resin; (c) selecting front and rear thermoplastic sheets for covering at least partially the second layer of fibers, for forming part of the respective front and rear external surfaces of the blade element and for increasing the impact resistance of the hockey stick blade; (d) placing the front and rear thermoplastic sheets and the preformed blade in a mold such that the preformed blade is between the front and rear thermoplastic sheets; (e) applying heat to the mold; and (f) when said resin is cured, removing the hockey stick blade from the mold.

Other objects and features of the invention will become apparent by reference to the following description and the drawings.

### BRIEF DESCRIPTION OF THE DRAWINGS

A detailed description of the embodiments of the present invention is provided herein below, by way of example only, with reference to the accompanying drawings, in which:

FIG. 1 is a perspective view of a hockey stick blade constructed in accordance with the invention;

FIG. 2 is a perspective view of the blade of FIG. 1 with layers being peel off;

FIG. 3 is a perspective view of first and second core portions used in the construction of the blade of FIG. 1;

FIG. 4 is a cross sectional view taken along line 4-4 of FIG. 1;

FIG. 5 is a perspective view of the first and second core portions of FIG. 4 with first and second fibers braids used in the construction of the blade of FIG. 1;

FIG. 6 is a perspective view of the first and second core portions and first and second fibers braids of FIG. 5 with a further fibers braid used in the construction of the blade of FIG. 1;

FIG. 7 is a perspective view of the first and second core portions and the fibers braids of FIG. 6 with a further fibers braid used in the construction of the blade of FIG. 1;

FIG. 8 is a perspective view of the blade of FIG. 1 before the molding operation;

FIG. 9 is a cross sectional view taken along line 9-9 of FIG. 8;

FIG. 10 is a perspective view of the preformed blade of FIG. 8 with sheets of thermoplastic material used in the construction of the blade of FIG. 1; and

FIG. 11 is a perspective view of a mold and the preformed blade with the sheets of thermoplastic material.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF THE EMBODIMENTS

To facilitate the description, any reference numeral designating an element in one figure will designate the same element if used in any other figures. In describing the embodiments, specific terminology is resorted to for the sake of clarity but the invention is not intended to be limited to the specific terms so selected, and it is understood that each specific term comprises all equivalents.

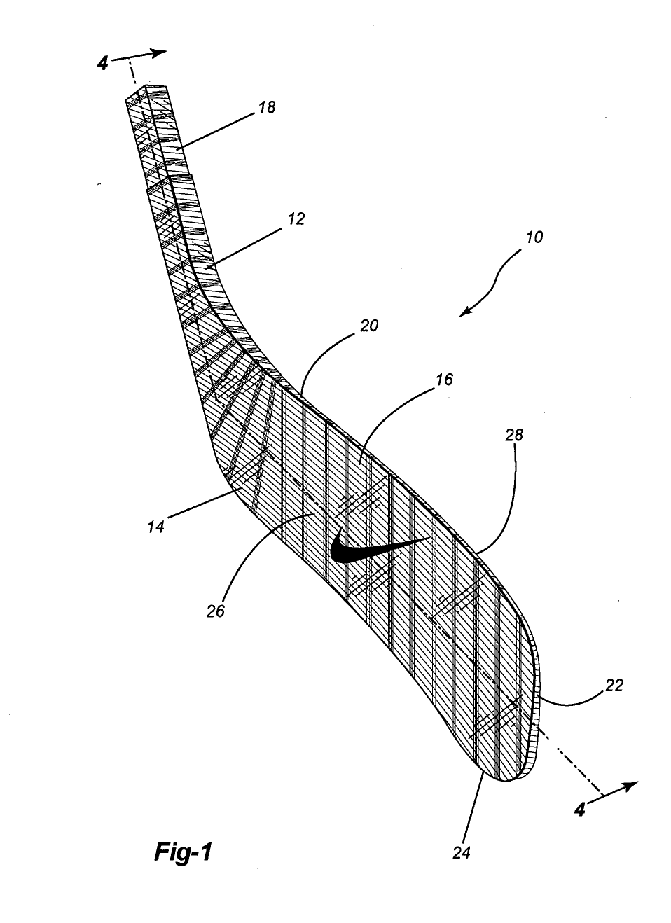

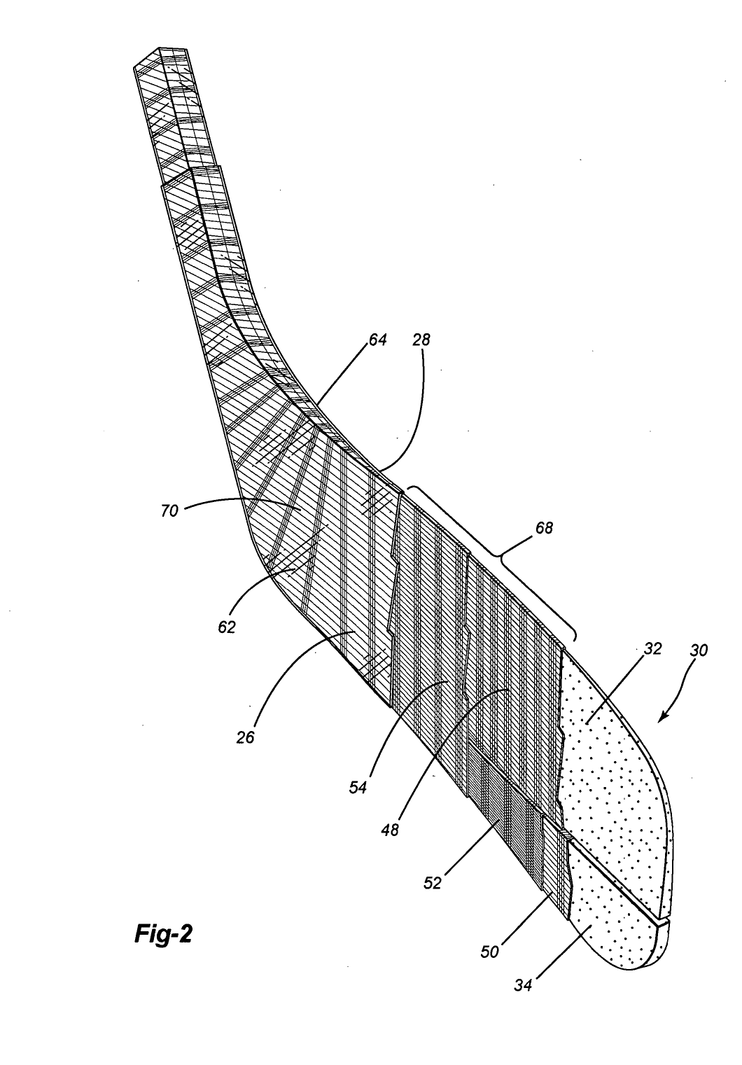

FIGS. 1 and 2 illustrate a hockey stick blade 10 constructed in accordance with the invention. The blade 10 comprises a shank 12, a heel section 14 and a blade element 16. The heel section 14 is located at the junction of the shank 12 and the blade element 16. The shank 12 comprises a tenon 18 adapted to be inserted into a hollow hockey stick shaft made of aluminum, composite or graphite. It is understood that instead of having the tenon 18, the shank 12 can be integrally formed with a hockey stick shaft.

The blade 10 comprises a top edge 20, a tip edge 22 and a bottom edge 24. The blade 10 also comprises a front surface 26 defined by the front surface of the blade element 16 and the front surface of the shank 12; and a rear surface 28 defined by the rear surface of the blade element 16 and the rear surface of the shank 12.

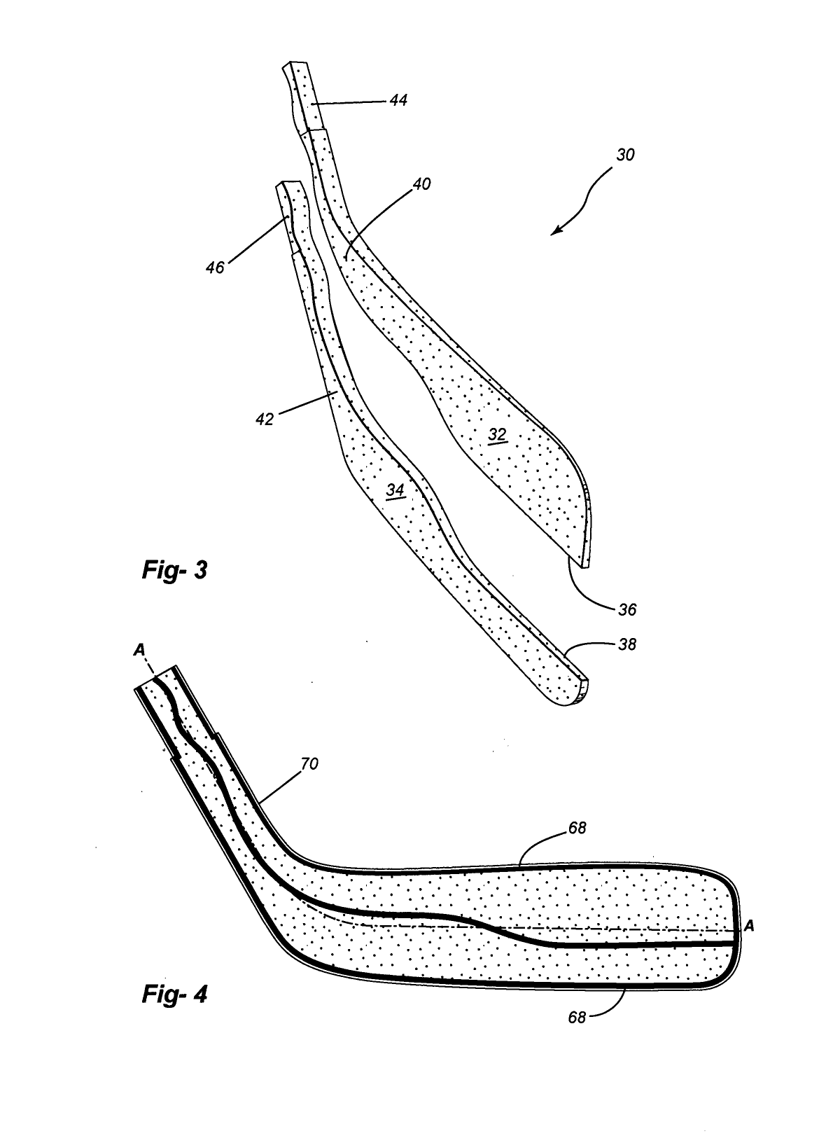

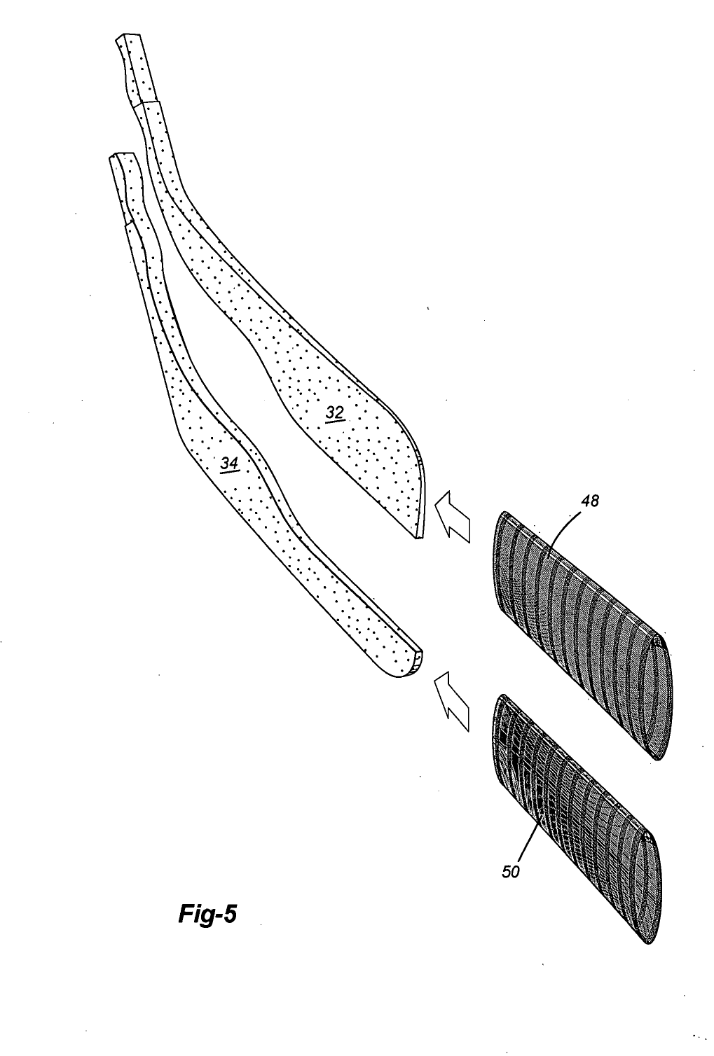

As shown in FIGS. 3 and 4, the blade 10 comprises a core 30 extending along a longitudinal axis A-A. The core 30 comprises a first portion 32 located above and aligned with a second portion 34. The first and second portions 32, 34 are dimensioned such as to have the shape of a blade when aligned with one another.

The first portion 32 comprises a bottom surface 36 and extends from the heel section 14 to the tip edge 22. The first portion 32 is generally delimited by its bottom surface 36 and the planes defined by the top and tip edges 20, 22. The second portion 34 comprises a top surface 38 and extends from the heel section 14 to the tip edge 22. The second portion 34 is generally delimited by its top surface 38 and by the planes defined by the bottom and tip edges 24, 22. As shown in FIG. 3, the first and second portions 32, 34 may further comprise respective shank portions 40, 42 defining the core of the shank 12, these shank portions 40, 42 comprising respective tenon portions 44, 46. The shank portions 40, 42 generally extend upwardly and rearwardly from the heel section 14. Hence, the core 30 comprises the first portion 32 with its shank portion 40 and the second portion 34 with its shank portion 42.

It is understood that the core may comprise first and second portions that do not comprise respective first and second shank portions. In fact, the first and second portions of the core may be confined to the blade element of the hockey stick blade (from the heel section to the tip edge) and the shank may be a separate component that is joined to the blade element. For example, the shank may be made of wood and comprises a groove in which a tongue portion provided on the blade element is inserted for joining together both components.

The first and second portions 32, 34 are made of synthetic material such as a thermo-expandable foam selected in the group consisting of polyurethane foam, ethylene vinyl acetate (EVA) foam, polyvinyl chloride (PVC) foam, ethylene polypropylene foam and polyisocyanurate foam. For example, the first and second portions 32, 34 may be made of thermo-expandable polyurethane foam sold by General Plastic Manufacturing. The first and second portions 32, 34 may be cut from a sheet of foam.

Liquid foam may also be injected in a mold in order to form the first and second portions 32, 34.

The second portion 34 may be made of foam having a higher density than the one of s the first portion 32. For example, the first portion 32 may be made of foam having a density of between 6 to 12 lbs/cubic foot while the second portion 34 may be made of foam having a density of between 14 to 18 lbs/cubic foot. In one possible embodiment, the first portion 32 is made of foam having a density of 10 lbs/cubic foot and the second portion 34 is made of foam having a density of 15 lbs/cubic foot.

As shown in FIGS. 3 and 4, the bottom surface 36 of the first portion 32 and the top surface 38 of the second portion 34 extend generally along an irregular line. More particularly, the top surface 38 of the second portion 34 extends beyond the longitudinal axis A-A in the heel region such that the heel region of the blade 10 is mostly made of higher density foam. In the tip region, the bottom surface 36 of the first portion 32 extends beyond the longitudinal axis A-A such that the tip region of the blade 10 is mostly made of lower density foam in order to reduce the weight of the blade 10.

In another embodiment, the bottom and top surfaces of the respective first and second portions may both extend along the longitudinal axis of the blade.

In a further embodiment, the first and second portion 32, 34 may be made of a thermo-expandable foam of same density.

It is understood that the core 30 may be made of a single piece that is dimensioned such as to have the shape of the blade. This single piece may be cut from a sheet of foam. Liquid foam may also be injected in a mold in order to form a foam core having the shape of the blade.

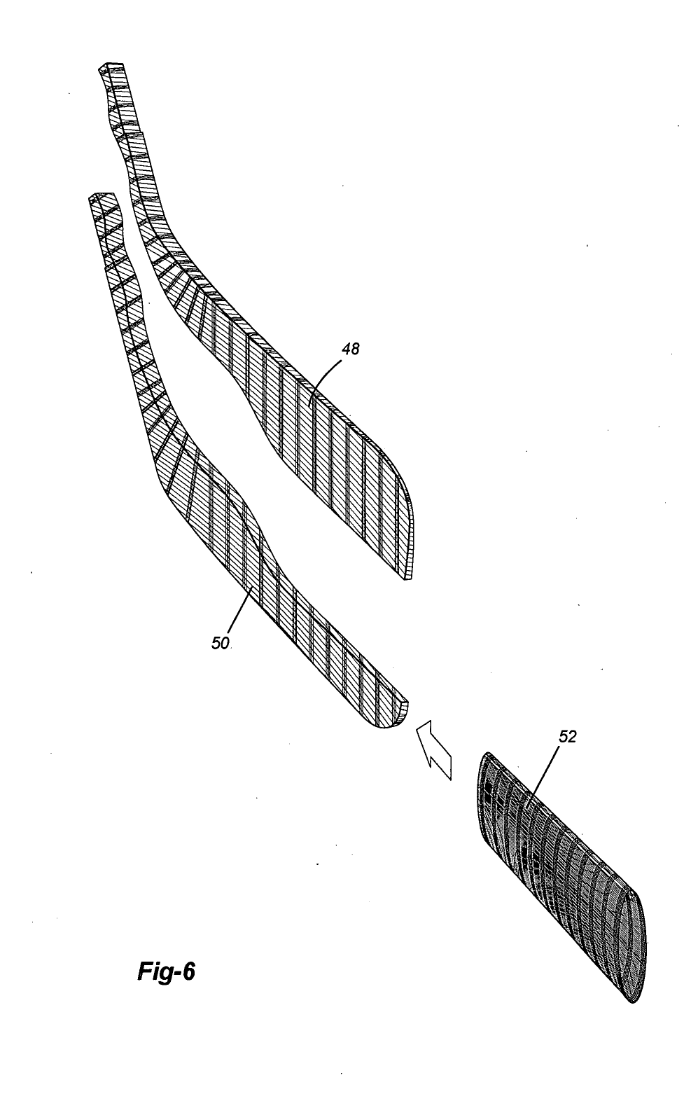

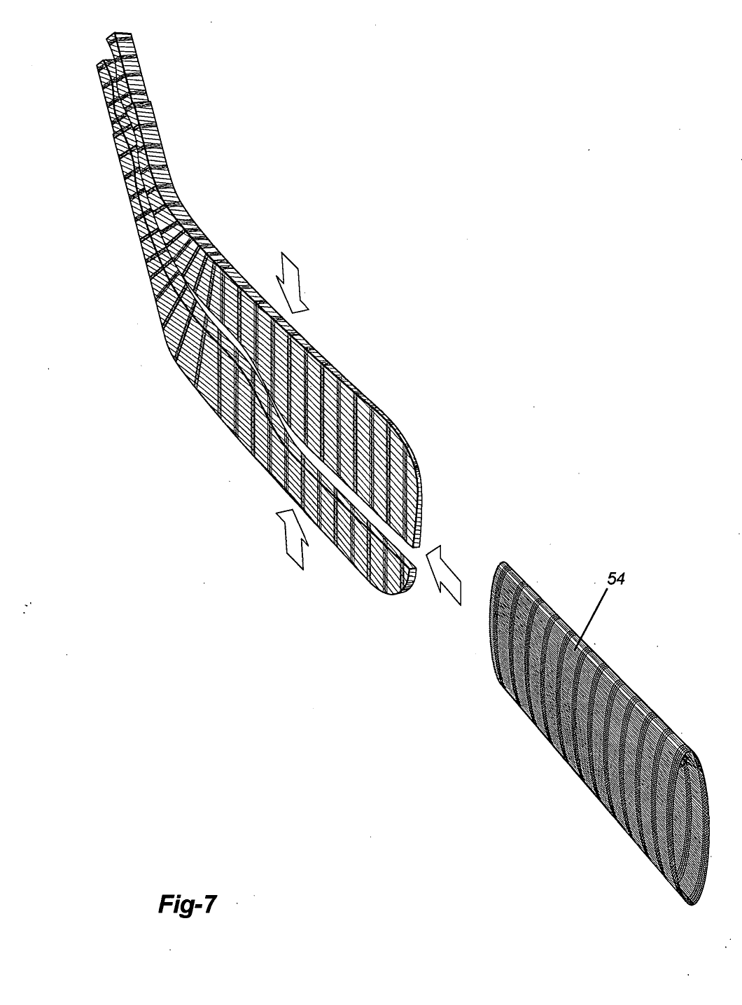

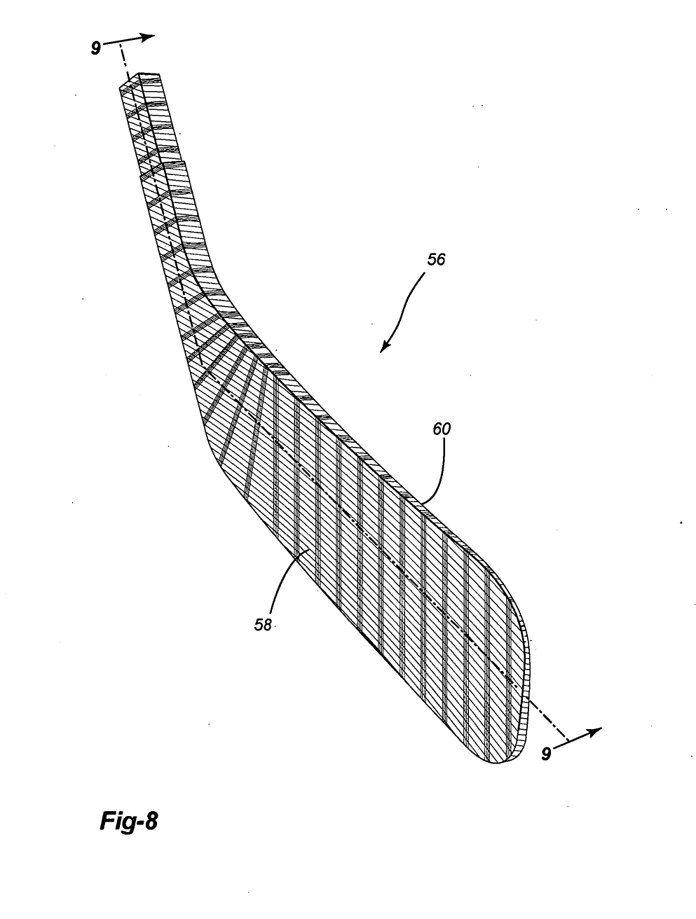

A method of making the blade 10 is hereinafter described. As shown in FIG. 5, a first fibers braid 48 is wrapped over the first portion 32 and a second fibers braid 50 is wrapped over the second portion 34. As shown in FIG. 6, a third fibers braid 52 is wrapped over the second fibers braid 50 of the second portion 34. As shown in FIG. 7, a fourth fibers braid 54 is wrapped over the first and third fibers braids 48, 52 of the first and second portions 32, 34 such as to realize a preformed blade 56 as illustrated in FIG. 8. Note that the preformed blade 56 has the general shape of a straight hockey stick blade and comprises front and rear faces 58, 60.

The fibers braids 48, 50, 52, 54 are expandable so as to conform to the shape of the first and second portions 32, 34 and are made of woven fibers selected from the group consisting of carbon fibers, glass fibers, KEVLAR fibers, ceramic fibers, boron fibers, quartz fibers, spectra fibers, polyester fibers and polyethylene fibers. For instance, a 3K carbon fibers braid, medium weight, commercialized by A & P Technology or Eurocarbon may be used. Moreover, the fibers braids 48, 50, 52, 54 may be made of fibers crossing at 45°. However, any other fibers crossing at between 30° and 60° may be used. Alternatively, layers of uni-directional or woven fiberglass, layers of uni-directional or woven carbon fibers or sheets of fibers may be used for covering the core 30. In another alternative construction, layers of pre-impregnated expandable fibers may be used for covering the core 30.

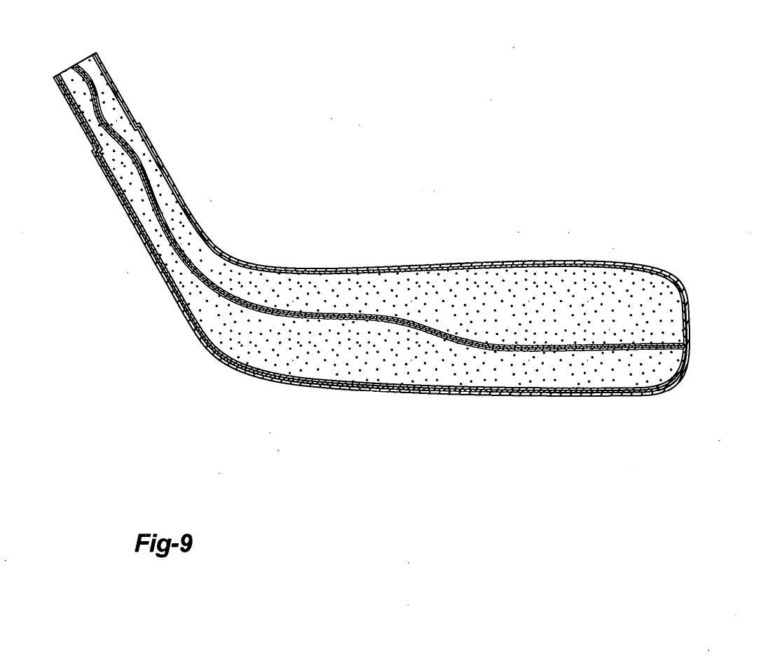

FIG. 9 shows a cross section view of the preformed blade 56 for illustrating the fibers braids before the molding process.

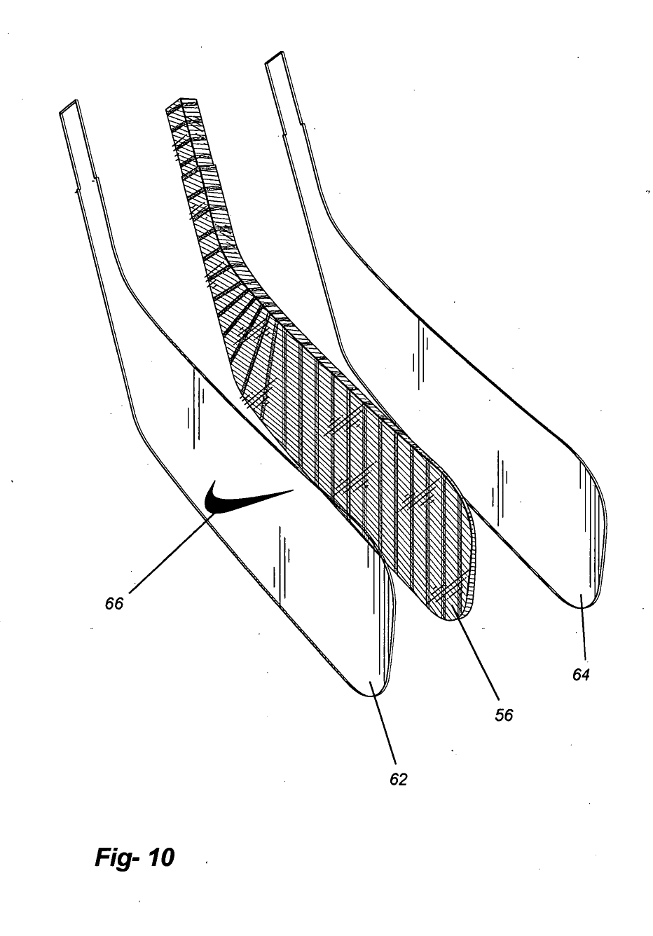

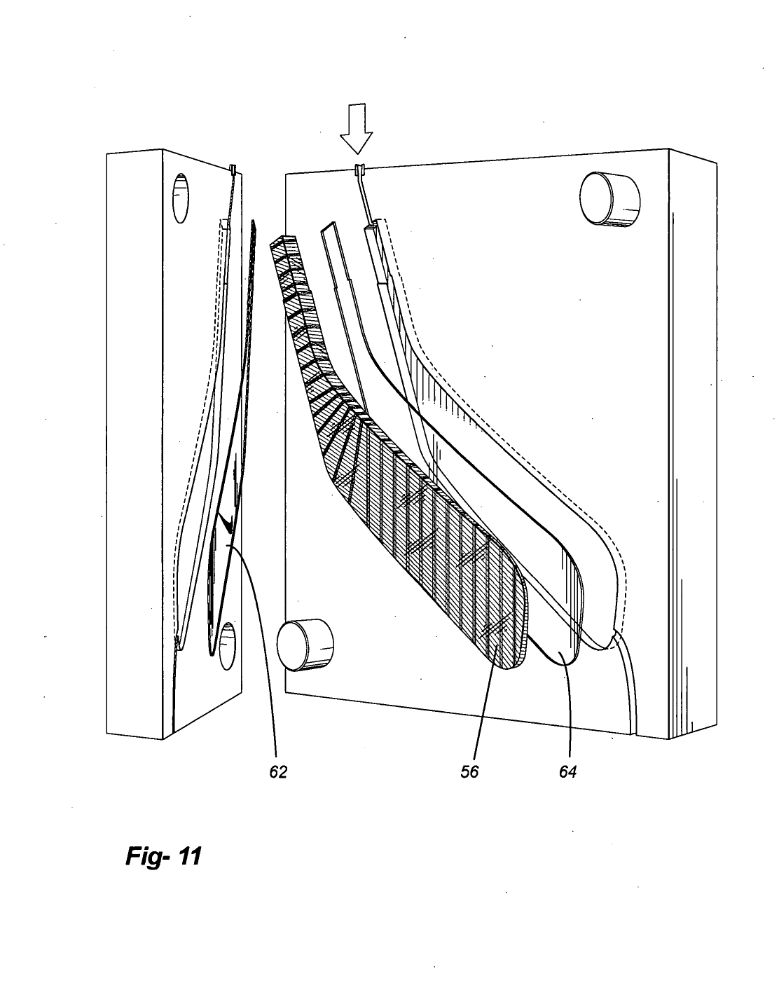

As shown in FIG. 10, front sheet 62 and rear sheet 64 are used for covering the respective front and rear faces 58, 60 of the preformed blade 56 in the construction of a blade 10. The sheets 62, 64 are made of a thermoplastic material selected in the group consisting of polyethylene, polyurethane, polypropylene, polyester, polystyrene, polyvinyl chloride and cellulose acetate. For example, the thermoplastic sheets 62, 64 may be made of thermoplastic polyurethane (TPU) sheets sold by Isosport IS under the name ISOCAP (density of 1.11 gr/cc and hardness of 73 D) or sold by Dow Chemical (density of 1.15-1.25 gr/cc and hardness of 73 D). Each of the thermoplastic sheets 62, 64 may have a contour that is slightly larger than that of the preformed blade 56 such that portions of the thermoplastic sheets 62, 64 covers the edges of the preformed blade 56. One of the sheets 62, 64 may comprise an indicia 66 that has been marked, engraved or printed thereon as shown in FIG. 10 (see the trade-mark SWOOSH Design of Nike). It is also understood that the contour of the sheets of thermoplastic material may be smaller than that of the preformed blade 56. Moreover, the sheets of thermoplastic material may only recover specific regions of the preformed blade 56. For example, only the regions of the preformed blade 56 that are more subject to impacts may be recovered with the sheets of thermoplastic material. In one embodiment, only the front face 58 may be recovered with a sheet of thermoplastic material; and such a sheet may entirely recovers the front face 58, or only a specific region of this front face 58 (only the heel region of the front face for example).

The preformed blade 56 and the thermoplastic sheets 62, 64 are afterwards inserted in a mold having the shape of the blade 10. A suitable resin (urethanes, araldite epoxy, vinylester, polycyanate or polyester resin) is then injected into the mold to impregnate the expandable fibers braids 48, 50, 52, 54 and heat is applied to the mold. A resin such as the resin sold by Ciba Specialty Chemicals Inc. under the name RESINFUSION may be used. The temperature of the mold may be between 85° C. and 125° C., the injection pressure of the resin may be between 25 psi and 75 psi and the injection temperature of the resin may be between 20° C. and 30° C. A vacuum pump may be mounted on the mold for easing the flow of resin through the fibers braids. Owing to the shape to the internal cavity of the mold, the preformed blade 56 is curved to any desired curvature typically used by hockey players such as to obtain the blade 10.

When the resin is cured, the mold is opened and the blade 10 is removed. Excess resin and material along the edges of the blade are removed with quick trimming and sanding operations.

Once the resin is injected in the fibers braids and the fibers-resin matrix is cured (see large lines on FIG. 4), the blade 10 comprises an interface between the first and second portions 32, 34, this interface comprising fibers oriented transversely relative to the longitudinal axis A-A.

As best shown in FIGS. 2 and 4, the blade 10 comprises (a) the core 30 formed of the first and second portions 32, 34; (b) a layer of fibers 68 recovering the core 30, this layer being formed of a first layer of fibers comprising the fibers braids 48, 50, 52 and a second layer of fibers comprising the fibers braid 54; and (c) a layer of thermoplastic material 70 recovering the layer of fibers. It is understood that, when the resin is cure, the layer of fibers 68 comprises fibers impregnated into the resin (see large lines in FIG. 4).

The layer of thermoplastic material 70 comprises the front and rear sheets 62, 64 and forms part of the front and rear surfaces of the blade element 16 and the front and rear surfaces of the shank 12 (i.e. front and rear surfaces 26, 28). In other words, the front and rear surfaces of the blade element 16 and the shank 12 comprise the layer of thermoplastic material 70, more precisely, the respective front and rear thermoplastic sheets 32, 34. Should the front and rear thermoplastic sheets 62, 64 have a shape that is slightly larger than that of the preformed blade 56, then the layer of thermoplastic material 70 may also cover the edges of the preformed blade 56 and forms part of the edges 20, 22, 24 of the blade 10.

As indicated previously, the contour of the thermoplastic sheets 62, 64 may be smaller than that of the preformed blade 56 such that the layer of thermoplastic material may only cover specific regions of the blade 10. For example, only the regions of the blade 10 that are more subject to impacts may be covered with the layer of thermoplastic material. In one embodiment, only the front surface 26 of the blade may be formed of a thermoplastics layer. Indeed, it is known that the front surface of the blade is more subject to impacts. In another embodiment, only specific regions of the front surface 26 may be formed of a thermoplastic layer (only the heel and middle regions of the blade 10 for example).

Because the front and rear surfaces 26, 28 of the blade 10 comprises the layer of thermoplastic material 70, the impact resistance of the blade 10 is greater than that of a blade having no external layer of thermoplastic material. For example, for the same blade construction, drop tests shown that the impact resistance increases of at least 50% for a blade having an external layer formed of a thermoplastic polyurethane (TPU) sheet sold by Isosport IS under the name ISOCAP and at least 70% for a blade having an external layer formed of a thermoplastic polyurethane (TPU) sheet sold by Dow Chemical (density of 1.15-1.25 gr/cc and hardness of 73 D).

The above description of the embodiments should not be interpreted in a limiting manner since other variations, modifications and refinements are possible within the spirit and scope of the present invention. The scope of the invention is defined in the appended claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A method of making a hockey stick blade with a shank and a blade element having a front external surface and a rear external surface, said method comprising:
(a) selecting a core made of thermo-expandable foam;
(b) forming a preformed blade by wrapping said core with first and second layers of fibers pre-impregnated with resin;
(c) selecting front and rear thermoplastic sheets for covering at least partially said second layer of fibers, for forming part of said respective front and rear external surfaces of said blade element and for increasing the impact resistance of said hockey stick blade;
(d) placing said front and rear thermoplastic sheets and said preformed blade in a mold such that said preformed blade is between said front and rear thermoplastic sheets;
(e) applying heat to the mold; and
(f) when said resin is cured, removing said hockey stick blade from the mold.

31. A method as defined in claim 30, wherein said selection of said core comprises selecting a first portion for placing above a second portion.

32. A method as defined in claim 31, wherein said first layer of fibers comprises a first fibers braid covering said first portion and a second fibers braid covering said second portion.

33. A method as defined in claim 32, wherein said second layer of fibers comprises a third fibers braid covering said first and second fibers braids.

34. A method as defined in claim 33, wherein said first and second layers of fibers are made of woven fibers selected from the group consisting of carbon fibers, glass fibers, KEVLAR fibers, ceramic fibers, boron fibers, quartz fibers, spectra fibers, polyester fibers and polyethylene fibers.

35. A method as defined in claim 34, wherein said first, second, third and fourth fibers braids are made of fibers crossing at between 30° and 60°.

36. A method as defined in claim 31, wherein said blade comprises an interface between said first and second portions, said interface comprising fibers oriented transversely relative to a longitudinal axis of said core.

37. A method as defined in claim 30, wherein said selection of said front and rear sheets of thermoplastic material comprises selecting a thermoplastic material selected from the group consisting of polyethylene, polyurethane, polypropylene, polyester, polystyrene, polyvinyl chloride and cellulose acetate.

38. A method as defined in claim 30, wherein said selection of said core comprises selecting a thermo-expandable foam selected from the group consisting of polyurethane foam, ethylene vinyl acetate (EVA) foam, polyvinyl chloride (PVC) foam, ethylene polypropylene foam and polyisocyanurate foam.

39. A method as defined in claim 30 further comprising selecting a front or a rear thermoplastic sheet that comprises an indicia.
